(19) United States
(12) Patent Application Publication
(10) Pub. No.: US 2015/0122404 A1
(43) Pub. Date: May 7, 2015

(54) Method of Decorating Glassware with Jewelry

(71) Applicant: Vanessa Allen, Palmdale, CA (US)

(72) Inventor: Vanessa Allen, Palmdale, CA (US)

(21) Appl. No.: 14/533,853

(22) Filed: Nov. 5, 2014

Related U.S. Application Data
(60) Provisional application No. 61/900,149, filed on Nov. 5, 2013.

(51) Int. Cl. B44C 3/12; B32B 37/12; B32B 38/00; B44C 5/00

(52) U.S. Cl. CPC B44C 3/12; B44C 5/00; B32B 37/12; B32B 38/0012
USPC 156/196

(57) ABSTRACT

A method for decorating glassware with prefabricated jewelry provides an artistic and aesthetic glassware display piece or glassware for household use. The jewelry is prepared and reshaped to mount onto the piece of glassware, as well as to one another. The jewelry within the plurality of ornaments is stacked and adhered to each other defines an aesthetic assemblage, where as the jewelry included in the plurality of decorations is directly mounted to the piece of glassware around the aesthetic assemblage. Before the adhesive has fully cured, the arrangement of the aesthetic assemblage and the plurality of decorations can be modified and revised into a final design.

The current application claims a priority to the U.S. Provisional Patent application Ser. No. 61/900,149 filed on Nov. 5, 2013.

### FIELD OF THE INVENTION

The present invention relates generally to a method for decorating and adorning glassware. More specifically, the present invention describes a method to mount pre-fabricated costume and fine jewelry onto glassware for an aesthetic appeal.

### BACKGROUND OF THE INVENTION

Glassware, such as vases and glasses, is used throughout the world and are a found in many homes. Often utilized for practical purposes, there are some who display high quality glassware, sometimes even going as far as to use them only as a display piece. Clearly there is a demand for ornamental glassware, visually pleasing and well suited for display.

There are a number of ways in which glassware can be decorated. Decorative flairs and accents can be integrated during the glass blowing process, or added afterwards via dyes or paints. In other instances decorative pieces are added to the glassware. Generally, these decorative pieces are specifically provided for the glassware. While this is certainly acceptable, it ignores a larger source of decorative pieces in the form of jewelry, which provide an easily accessed and easy to customize source of decorative pieces.

The present invention addressed the creation of custom and handcrafted jewelry vases and wine glasses by using pre-fabricated costume and fine jewelry such as brooches, rings, necklaces, earrings, buttons, barrettes, pearls, belt buckles, shoe buckles, lace or fabric materials, pendants, chains, stones, metal, and watches to create a costume jeweled glass art work through cutting, shaping, bending, jewelry stacking, and redesigning jewelry pieces to bring about the pictured effect purposed by the artist.

To accomplish the artwork, the costume jewelry glasswork is created through utilization of various jewelry tools such as ring bending pliers, flush end cutter pliers, wire cutter pliers, a soldering iron, and other jewelry making tools, in addition to the application of various nitrocellulose compound polishes for re-coloring and glazing of the jewelry pieces as well as for preservation of the jewelry designed glasswork. The redesigned costume art work is then attached to the glassware in a recreated designed art by applying an adhesive and various coloring of some of the jewelry.

### BRIEF DESCRIPTION OF THE DRAWINGS

FIG. 1 is a flow diagram for the overall method of the present invention.

FIG. 2 is a flow diagram detailing the process of creating the aesthetic assemblage.

FIG. 3 is a flow diagram detailing the process of mounting the plurality of decorations.

FIG. 4 is a flow diagram depicting the repositioning process of a selected object on the piece of glassware.

FIG. 5 is an exemplary result of the present invention.

FIG. 6 is an exemplary result of the present invention.

FIG. 7 is an exemplary result of the present invention.

FIG. 8 is an exemplary result of the present invention.

FIG. 9 is an exemplary result of the present invention.

### DETAIL DESCRIPTIONS OF THE INVENTION

All illustrations of the drawings are for the purpose of describing selected versions of the present invention and are not intended to limit the scope of the present invention.

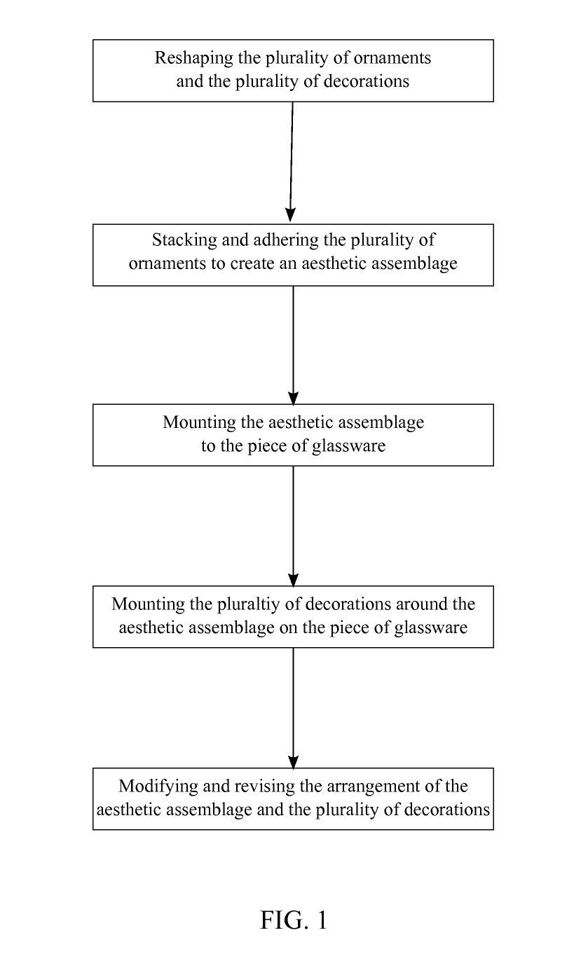

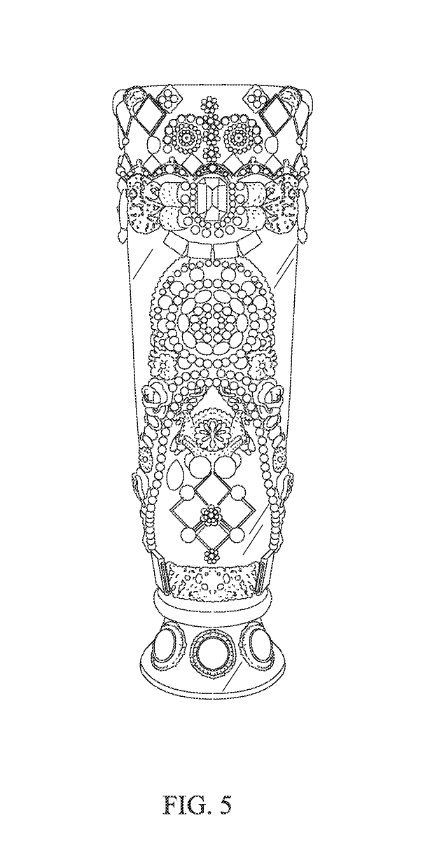

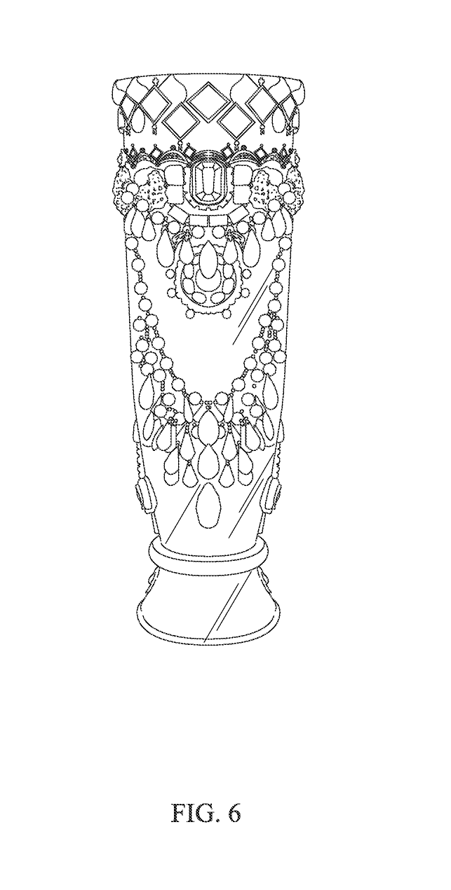

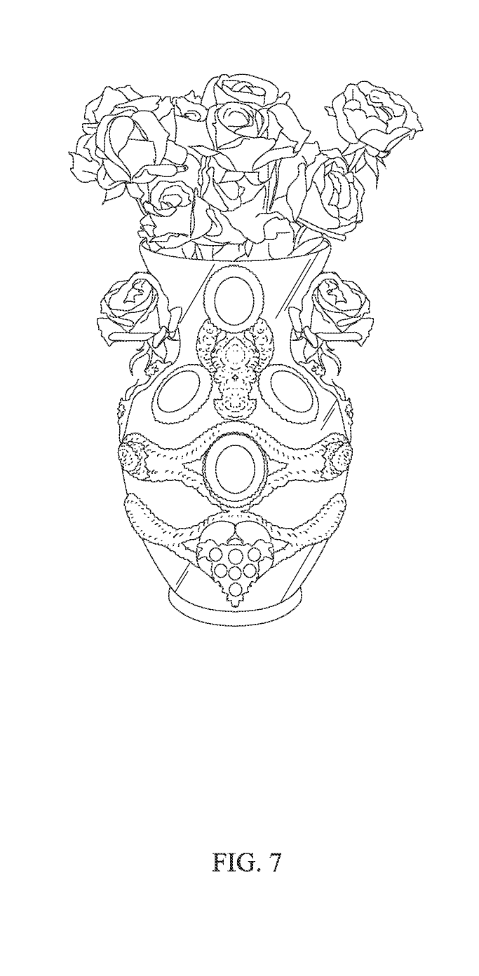

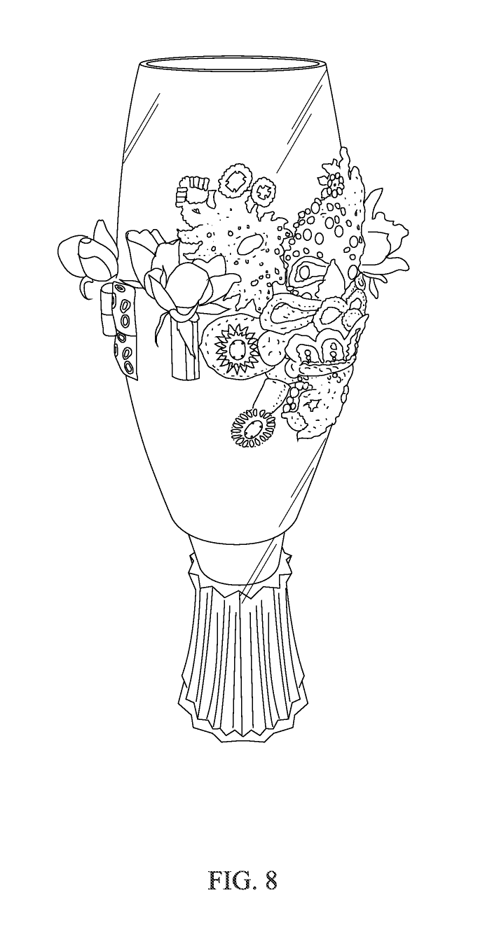

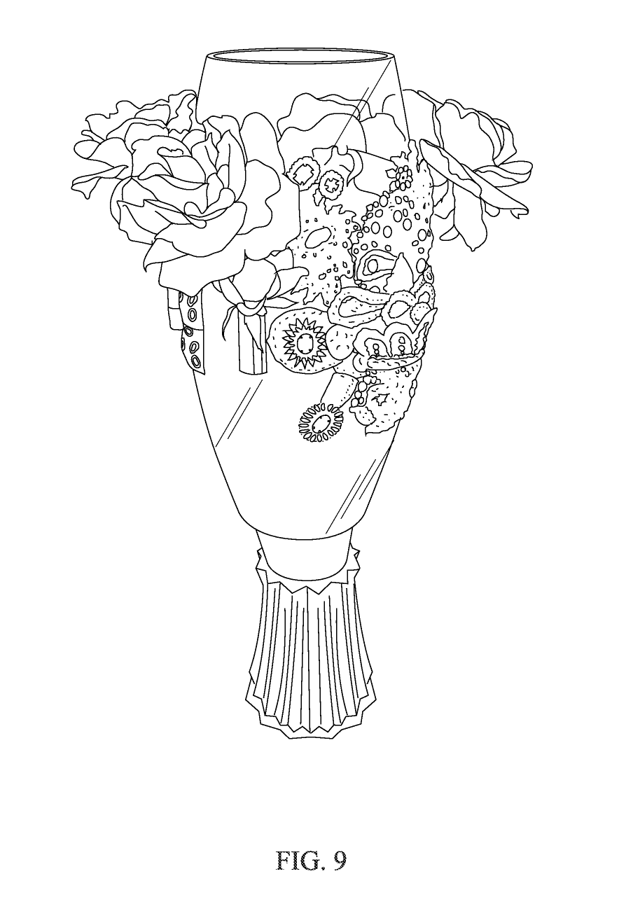

The present invention is a method for decorating glassware with jewelry to provide an aesthetic design on the exterior of the glassware, exemplified in FIG. 5 to FIG. 9. The present invention makes use of a piece of glassware, a plurality of ornaments and a plurality of decorations. A piece of glassware is selected from, but it not limited to, vases, glass beverage containers, and other household or decorative glassware. The piece of glassware provides a base for the plurality of ornaments and the plurality of decorations to be mounted. The plurality of ornaments and the plurality of decorations are selected from, but not limited to, traditional costume and fine jewelry such as brooches, rings, necklaces, earrings, buttons, barrettes, pearls, belt buckles, shoe buckles, lace or fabric materials, pendants, chains, precious stones, metals, and watches. In accordance to FIG. 1, the plurality of decorations are reshaped and configured to be mounted on the piece of glassware in accordance to a predetermined design. The plurality of ornaments is reshaped and stacked by adhering each together in order to form an aesthetic assemblage. The aesthetic assemblage is subsequently mounted onto the piece of glassware. The predetermined design for the placement of the aesthetic assemblage and the plurality of decorations is then modified and revised into the intended final design that the artist or the user of the presented method perceives.

The final design is achieved by first reshaping the plurality of ornaments and the plurality of decorations. Using various jewelers' tools, such as ring bending pliers, flush end cutter pliers, wire cutters, and other jewelry crafting tools, the plurality of ornaments and the plurality of decorations are disassembled and reformed. Given a specific piece of jewelry from either the plurality of decorations or the plurality of ornaments, an interfacing portion of the specific piece of jewelry is reshaped in order to conform to an external contour for the piece of glasswork. The interfacing portion is subsequently adhered on the external contour. Sometimes the specific piece of jewelry chosen includes a body/clothing mount. The body/clothing mount includes, but is not limited to, an earring pins and backings, clasps, clips, chains, hooks, and other means of attaching jewelry to a person. When the body/clothing mount can interfere with mounting the specific piece of jewelry onto the piece of glassware, the body/clothing mount is physically separated from the specific piece of jewelry. The body/clothing mount is separated in order for the specific piece of jewelry to more easily conform and mount onto the piece of glassware.

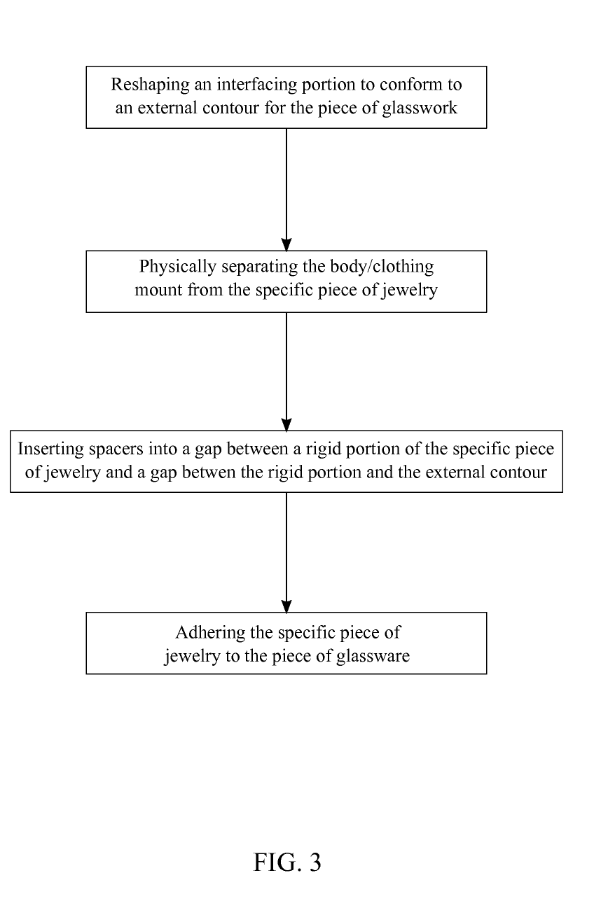

In accordance to FIG. 3, a rigid portion is identified for the specific piece of jewelry which prevents the specific piece of jewelry from conforming to the contour of the piece of glassware. At least one gap between the rigid portion and the external contour may be present if the specific piece of jewelry is mounted directly onto the glassware, limiting the support and area covered by an adhesive means of mounting. By identifying the at least one gap, at least one spacer is inserted into the at least one gap to form the interfacing portion. The interfacing portion will have a larger surface area and would be easier to support on the piece of glassware using an adhesive. The spacer can be cylindrical, rectangular, triangular, or another similar shape that provides both aesthetic appeal with the overall design as well as support for the specific piece of jewelry.

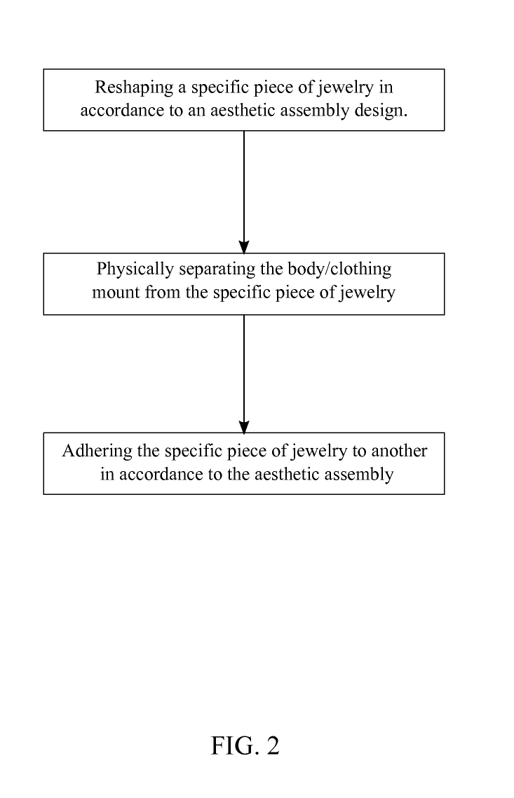

Once the plurality of ornaments and the plurality of decorations are reshaped, the plurality of ornaments are stacked and adhered onto each other to create an aesthetic assemblage, in accordance to FIG. 2. The aesthetic assemblage is a three-dimensional collage of the plurality of ornaments. In order to create the three-dimensional effect from the plurality of ornaments, any two from the plurality of ornaments, at a time, are shingled and adhered to each other within the aesthetic assemblage such that the prominent features of the two from the plurality of ornaments are displayed. Further, other ornaments within the plurality of ornaments are attached to create the ultimate appearance. In addition, any two from the plurality of ornaments can be adjacently positioned and adhered to each other within the aesthetic assemblage, such that those two of the plurality of ornaments are displayed in full.

During the adhering process, it is possible that too much adhesive may be used while compiling the plurality of ornaments into the aesthetic assemblage. The weight of the aesthetic assemblage may cause the aesthetic assemblage to be hard to attach to the piece of glassware where more adhesive must be used to compensate for the weight. When an excessive amount of adhesive is used, the excess adhesive may visibly seep out as the aesthetic assembly and the plurality of decorations are connected to the piece of glassware. The excess adhesive can be unsightly, unwanted in the final design and sometimes hard to remove efficiently due to the irregular shapes of the plurality of ornaments and the plurality of decorations. By adhering lustrous objects to the aesthetic assemblage and the piece of glassware with the excess adhesive, the excess adhesive is less visually obvious while strengthening the bond between the plurality of ornaments within the aesthetic assemblage, the plurality of decorations, and the piece of glassware. Possible lustrous objects include, but are not limited to, crystals, metals, gems, glitter, beads, and other objects which provide a gleaming or aesthetically pleasing effect consistent with the predetermined design.

In further accordance to the adhering process, objects are selected of the aesthetic assemblage and each of the plurality of decorations to be permanently mounted to the piece of glassware. By sequentially orienting the piece of glassware, each object is mounted onto the piece of glassware in accordance to the predetermined design. The selected objects are sequentially adhered to the piece of glassware at a predetermined interval. The predetermined interval is the length of time required for the adhesive to cure, such that each of the objects to set onto the piece of glassware. When the selected objects are made of a material that reacts adversely with the adhesive, such as an acrylic materials, each of the selected objects are set into an inlay and subsequently attached to the piece of glassware through the inlay. The inlay allows the selected object to be mounted onto the piece of glassware without reacting with the adhesive.

Alternatively to being permanently mounted, objects from the aesthetic assemblage and the plurality of decorations may be selected to be removably mounted to the piece of glassware. Similar to adhering the selected objects, the piece of glassware is sequentially oriented in order to mount each of the selected objects in accordance to the predetermined design in order to be sequentially and removably fastened onto the piece of glassware. Examples of fastening mechanisms include, but are not limited to, clips, clasps, hooks, etc. which attach to chains, links, other objects within the plurality of decorations, and other objects within the plurality of ornaments.

In an alternate embodiment where the piece of glassware comprises a stem, selected objects from the aesthetic assemblage and the plurality of decorations are positioned on the stem. The selected objects are oriented about and externally mounted to the stem. The mounting method is similarly is either an adhesive or a fastening mechanism.

The present invention of mounting costume and fine jewelry lends itself to using a plethora of jewelry types and styles, some of which may be tattered and tarnished through age and previous use. Select objects from the aesthetic assemblage and the plurality of decorations are chosen to be re-colored, protected and restored. The selected objects are glazed with a polish compound in order to change the color of the objects, to provide a protective coating, or provide a lustrous finish. In the preferred embodiment, the polish compound is made from a nitrocellulose solute dissolved into either a butyl acetate or ethyl acetate solvent. A clear polish compound preserves the shine of the original jewelry; where as a colored compound is used to match the predetermined design color scheme.

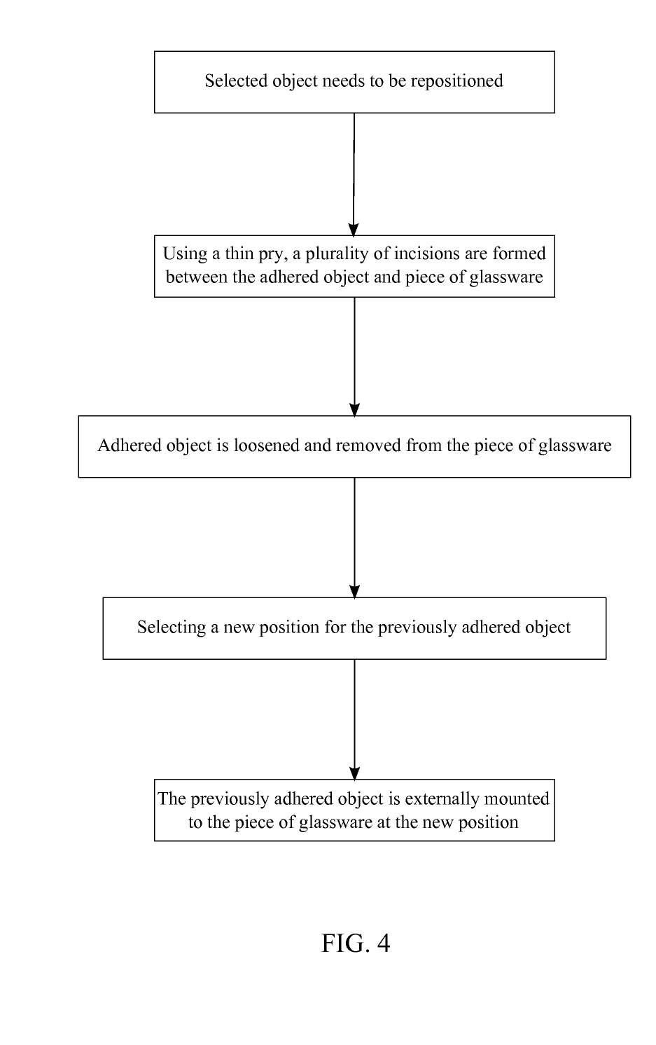

While the adhesive is in the curing process, it may be necessary to adjust and rearrange the aesthetic assemblage and the plurality of decorations. Repositioning the specific piece of jewelry may be necessary in order to accommodate the size and shape of the specific jewelry pieces on the piece of glassware. In accordance to FIG. 4, in order to remove selected objects from the piece of glassware during the adhesion curing process, a plurality of incisions are formed between the adhered object and the piece of glassware by inserting a thin pry. Following the incisions the adhered object is loosened and removed from the piece of glassware. Once the selected object is removed, a new position to adhere the object is selected. The previously adhered object is then mounted in the new location.

In accordance to the preferred embodiment, selected objects from the aesthetic assemblage and the plurality of decorations comprise an attachment receiving hole. The selected objects are externally mounted onto the piece of glassware. Through the attachment receiving hole, additional decorative elements, such as flowers, bows, ribbons, etc., are hung onto the piece of glassware.

Although the invention has been explained in relation to its preferred embodiment, it is to be understood that many other possible modifications and variations can be made without departing from the spirit and scope of the invention as hereinafter claimed.

What is claimed is:

1. A method of decorating glassware with jewelry, the method comprises the steps of:
providing a piece of glassware, a plurality of ornaments, and a plurality of decorations;
reshaping the plurality of ornaments and the plurality of decorations in order to create a predetermined design on the piece of glassware;
stacking and adhering the plurality of ornaments onto each other in order to create an aesthetic assemblage;
externally mounting the aesthetic assemblage onto the piece of glassware;
externally mounting the plurality of decorations onto the piece of glassware around the aesthetic assemblage;
modifying arrangement of aesthetic assemblage and the plurality of decorations in order to revise the predetermined design into a final design;

2. The method of decorating glassware with jewelry, the method as claimed in claim 1 comprises the steps of:
providing a specific piece of jewelry, wherein the specific piece of jewelry is from the plurality of ornaments;
reshaping an interfacing portion into the specific piece of jewelry in order to conform to an external contour for the piece of glasswork;
adhering the interfacing portion to the external contour;

3. The method of decorating glassware with jewelry, the method as claimed in claim 2 comprises the steps of:
providing a body/clothing mount, wherein the body/clothing mount is from the specific piece of jewelry;
physically separating the body/clothing mount from the specific piece of jewelry;

4. The method of decorating glassware with jewelry, the method as claimed in claim 2 comprises the steps of:
identifying a rigid portion for the specific piece of jewelry, wherein the rigid portion is mounted to the piece of glassware;
identifying at least one gap between the rigid portion and the external contour;
inserting at least one spacer into the at least one gap in order to form the interfacing portion with the rigid portion and the at least one spacer;

5. The method of decorating glassware with jewelry, the method as claimed in claim 1 comprises the steps of:
providing a specific piece of jewelry, wherein the specific piece of jewelry is from the plurality of decorations;
reshaping an interfacing portion into the specific piece of jewelry in order to conform to an external contour for the piece of glasswork;
adhering the interfacing portion to the external contour;

6. The method of decorating glassware with jewelry, the method as claimed in claim 1 comprises the steps of:
providing a specific piece of jewelry with a body/clothing mount, wherein the specific piece of jewelry is from the plurality of decorations;
physically separating the body/clothing mount from the specific piece of jewelry;

7. The method of decorating glassware with jewelry, the method as claimed in claim 1 comprises the steps of:
shingling and adhering two of the plurality of ornaments to each other within the aesthetic assemblage;

8. The method of decorating glassware with jewelry, the method as claimed in claim 1 comprises the steps of:
adjacently positioning and adhering two of the plurality of ornaments to each other within the aesthetic assemblage;

9. The method of decorating glassware with jewelry, the method as claimed in claim 1 comprises the steps of:
wherein excess adhesive seeps out between the plurality of ornaments as the plurality of ornaments are connected together into the aesthetic assemblage;
adhering lustrous objects to the aesthetic assemblage by the excess adhesive;

10. The method of decorating glassware with jewelry, the method as claimed in claim 1 comprises the steps of:
selecting objects of the aesthetic assemblage and each of the plurality of decorations in order to be permanently mounted to the piece of glassware;
sequentially orienting the piece of glassware in order to mount each of the objects in accordance to the predetermined design;
sequentially adhering each of the objects to the piece of glassware for a predetermined interval, wherein the predetermined interval is the length of time required for each of the objects to set onto the piece of glassware;

11. The method of decorating glassware with jewelry, the method as claimed in claim 10 comprises the steps of:
wherein the objects are made of an acrylic material;
setting each of objects into an inlay;
adhering each of the objects to the piece of glassware through the inlay;

12. The method of decorating glassware with jewelry, the method as claimed in claim 1 comprises the steps of:
selecting objects from of the aesthetic assemblage and each of the plurality of decorations in order to be removably mounted to the piece of glassware;
sequentially orienting the piece of glassware in order to mount each of the objects in accordance to the predetermined design;
sequentially fastening each of the objects to the piece of glassware;

13. The method of decorating glassware with jewelry, the method as claimed in claim 1 comprises the steps of:
selecting objects from of the aesthetic assemblage and each of the plurality of decorations in order to color, protect, or restore the objects;
glazing the objects with a polish compound in order to change color of the objects or to provide the objects with a lustrous finish;

14. The method of decorating glassware with jewelry as claimed in claim 13, wherein the polish compound is made of a nitrocellulose solute and an either butyl acetate or ethyl acetate solvent.

15. The method of decorating glassware with jewelry, the method as claimed in claim 1 comprises the steps of:
selecting objects from of the aesthetic assemblage and each of the plurality of decorations in order to position onto a stem for the piece of glassware;
oriented the objects about the stem;
externally mounting the objects onto the stem;

16. The method of decorating glassware with jewelry, the method as claimed in claim 1 comprises the steps of:
wherein at least one adhered object from the aesthetic assemblage and the plurality of decorations are in an adhesion curing process;
forming a plurality of incisions between the adhered object and the piece of glassware by inserting a thin pry;
loosening and removing the adhered object from the piece of glassware;

17. The method of decorating glassware with jewelry, the method as claimed in claim 16 comprises the steps of:
selecting a new position for the adhered object within the predetermined design;
externally mounting the adhered object on the piece of glassware at the new position;

18. The method of decorating glassware with jewelry, the method as claimed in claim 1 comprises the steps of:
selecting objects from the aesthetic assemblage and each of the plurality of decorations, wherein the objects comprise an attachment receiving hole;
externally mounting the objects on the piece of glassware;
hanging additional decorative elements to the piece of glassware through the attachment receiving hole;
